(19) United States
(12) Patent Application Publication
(10) Pub. No.: US 2015/0015621 A1
(43) Pub. Date: Jan. 15, 2015

(54) ILLUMINATING A FIRST LIGHT SOURCE AND A SECOND LIGHT SOURCE OF A DISPLAY DEVICE

(71) Applicant: Lee Warren Atkinson, Houston, TX (US)

(72) Inventor: Lee Warren Atkinson, Houston, TX (US)

(21) Appl. No.: 14/384,771

(22) PCT Filed: Mar. 16, 2012
(86) PCT No.: PCT/US2012/029425

§ 371 Date: Sep. 12, 2014

(51) Int. Cl. G09G 3/34

(52) U.S. Cl. CPC G09G 3/342; G09G 3/3413; G09G 2320/0233; G09G 2320/0238; G09G 2320/0646; G09G 2320/0666; G09G 2320/062
USPC 345/690; 345/102

(57) ABSTRACT

A display device can include a first light source and a second light source different in color gamut than the first light source. It can be determined if an image to be displayed would benefit from the second light source.

### BACKGROUND

A display may include a back light to illuminate the display. The back light can include a light guide to distribute the light across the display. The light guide may be connected to a light such as a cold cathode florescent light bulb or a light emitting diode (LED) or both.

### BRIEF DESCRIPTION OF THE DRAWINGS

Some embodiments of the invention are described with respect to the following figures:

FIG. 1 is a block diagram of a computing system including a display light source according to an example implementation;

FIG. 2 is a gamut diagram according to an example implementation;

FIGS. 3a and 3b are display back light systems according to example implementations;

FIG. 4 is a block diagram of a computing system including a display light source according to an example implementation;

FIG. 5 is a flow diagram of a method of selectively increasing color gamut of a displayed image according to an example implementation;

FIG. 6 is a flow diagram of a method of selectively increasing color gamut of a displayed image according to an example implementation; and

FIG. 7 is a computing system including a computer readable medium according to an example implementation.

### DETAILED DESCRIPTION

A display can be back lit by a light source in the white gamut. A display can also be back lit with a light source with a gamut wider than the white gamut. To widen the color gamut of the light source different color light sources can be used for example a back light with a wider color gamut can include a red, green and blue light source such as light emitting diodes (LEDs). The color gamut is colors which can be accurately represented in a given circumstance, for example within an output device such as a display. A wide color gamut can more accurately represent an image on an output device than a narrow color gamut.

Lighting a display with red, green and blue sources can widen the color gamut that the display can produce if compared to a white light source. Increasing the number of LEDs to widen the color gamut may also increase the power drawn by the light source that illuminates the display. An example of when a wider color gamut may be a benefit can be related to the type of image. For example, if the type of image is an email it may not benefit from a wider color gamut however a photo may benefit from a wider color gamut. Other things such as ambient light, power state, power source, brightness of the display can also be considered when determining whether to display an image in a wide or narrow color gamut.

In one embodiment, a computing system can include a display device. A first light source in the white color gamut can be used to illuminate the display. A second light source different in color gamut than the first light source can be used to illuminate the display. A controller can illuminate the first light source in a first system condition and illuminate the second light source in a second system condition.

In another embodiment, a method can be to selectively increase color gamut of a displayed image. The method can include determining if an image to be displayed would benefit from a wide color gamut mode. A display can be illuminated with first light source if it is determined the image to be displayed would not benefit from the wide color gamut mode. A display can be illuminated with a second light source if it is determined the image to be displayed would benefit from the wide color gamut mode.

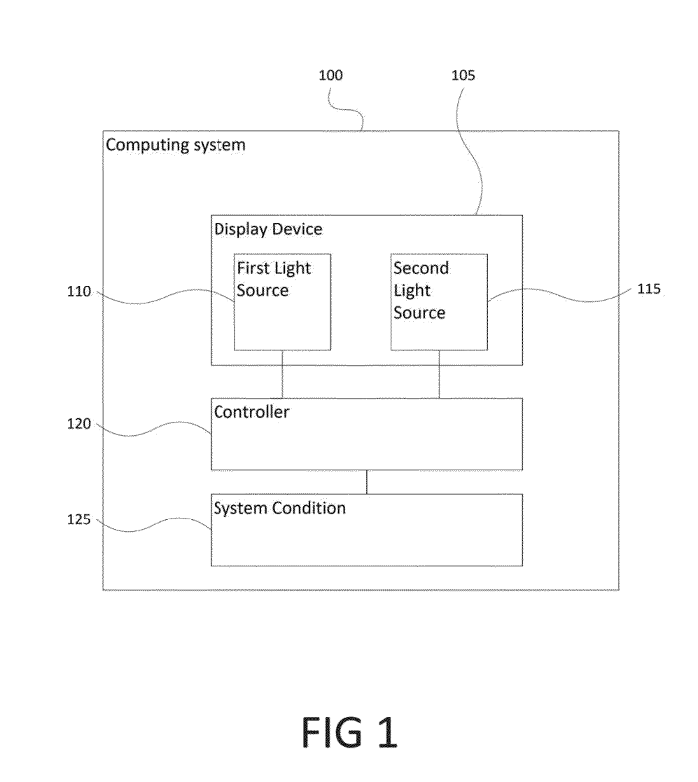

FIG. 1 is a block diagram of a computing system including a display light source according to an example implementation. A computing system 100 can include a display device 105. The display device 105 may be a liquid crystal display (LCD) or another display technology that is illuminated by a light source. The light source for the LCD may be light emitting diodes (LED). The light source may transmit light to a light guide that can illuminate the display. The light source for an LCD may edge light the light guide or may have light sources that are distributed across the display device 105.

A first light source 110 in the white color gamut can be used to illuminate the display. The first light source 110 may be a white LED. A second light source 115 different in color gamut than the first light source can be used to illuminate the display. The second light source 115 can be a color gamut that is wider than the color gamut of the first light source and may include one or more colors of LEDs such as red, green and blue.

A controller 120 can illuminate the first light source 110 in a first system condition 125 and illuminate the second light source 115 in a second system condition 125. The system condition may include for example power states, power source, display panel brightness, ambient light, software executing.

A power state may be an advanced configuration and power interface (ACPI) power state. For example if the configuration of the system is set to put the system in hibernate if the system battery reaches 5% remaining charge the system may limit the width of the color gamut of the display by not using the second light source to extend time that the computing system can operate on the same amount of battery charge.

A power source may be alternating current source versus direct current. For example the computing system may determine that on a direct current source such as a battery the wider gamut light source is not used. On an alternating current source such as a wall plug the computing system can use a wider color gamut source.

The panel brightness may be used to determine if the image would benefit from a wider color gamut. For example if the display device 105 is set to maximum brightness the controller may determine that a wider color gamut would improve the image displayed. If the display device 105 is set to a minimum brightness the controller may determine that the wider color gamut would not improve the image displayed since the brightness of the display device was at a minimum level.

The ambient light may be used to determine if the image would benefit from a wider color gamut. For example if there is ambient light above a threshold amount the controller may determine that a wider color gamut would improve the image displayed. If the ambient light is below a threshold the controller may determine that the wider color gamut would not improve the image displayed.

The type of software may also be used to determine if the image displayed would benefit from the wider color gamut. For example a photo editing software that displays photos may be determined to benefit from a wider color gamut. An email program may be determined not to benefit from a wider color gamut. Alternatively the image data can be analyzed to determine whether the image contains colors that benefit from a wide color gamut.

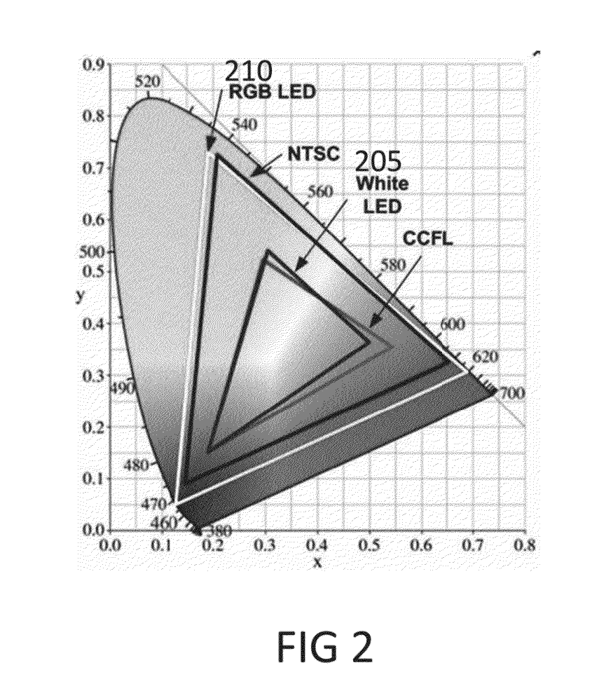

FIG. 2 is a gamut diagram according to an example implementation. The first light source may be the area of the color chart within the triangle 205 which represents a white light emitting diode (LED). The second light source may be the area of the color chart within the triangle 210 which represents RGB (red, green and blue) light emitting diodes (LED). The RGB LEDs 210 is capable of a wider color gamut than a white LED 205.

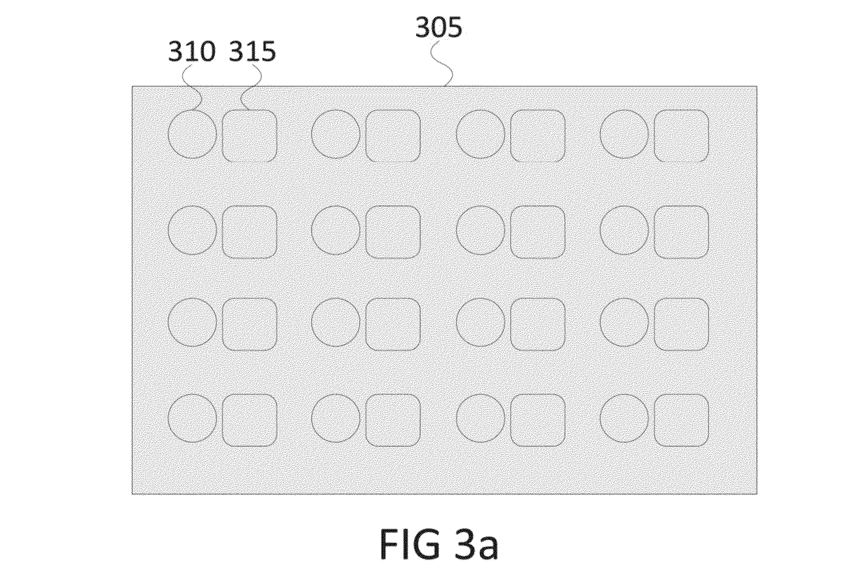

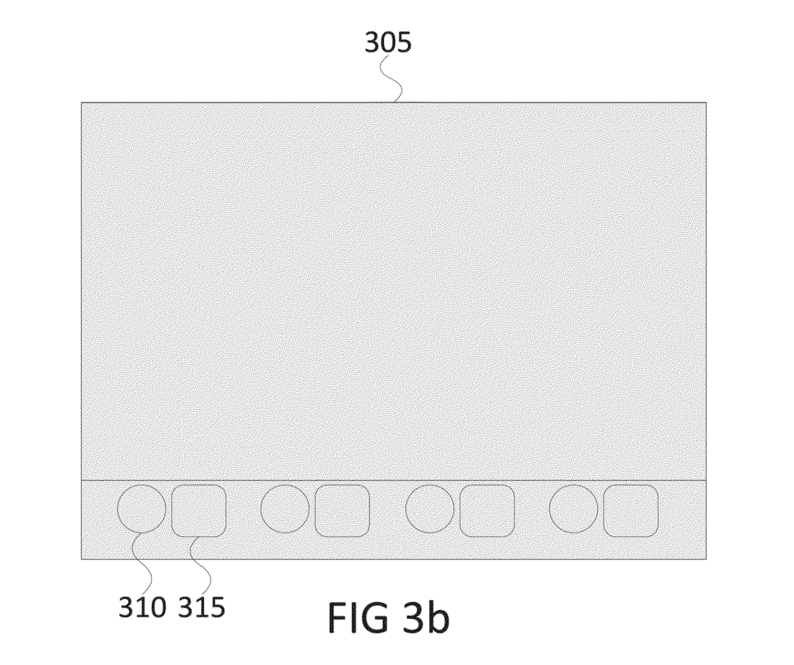

FIG. 3a and FIG. 3b are display device back light systems according to example implementations. FIG. 3a is a display device where the light sources are distributed throughout the display and FIG. 3b is a display device where the light sources are at an edge of the display device and illuminate a light guide. A display device 305 may include one or multiple first light sources and one or multiple second light sources. For explanation purposes the display device 305 includes first light sources 310 (circle) and second light sources 315 (square). When there are multiple first and second light sources the color gamut may be changed for different regions of the display. For example if the display was being partially used for reading email but another portion was used for looking at a photo.

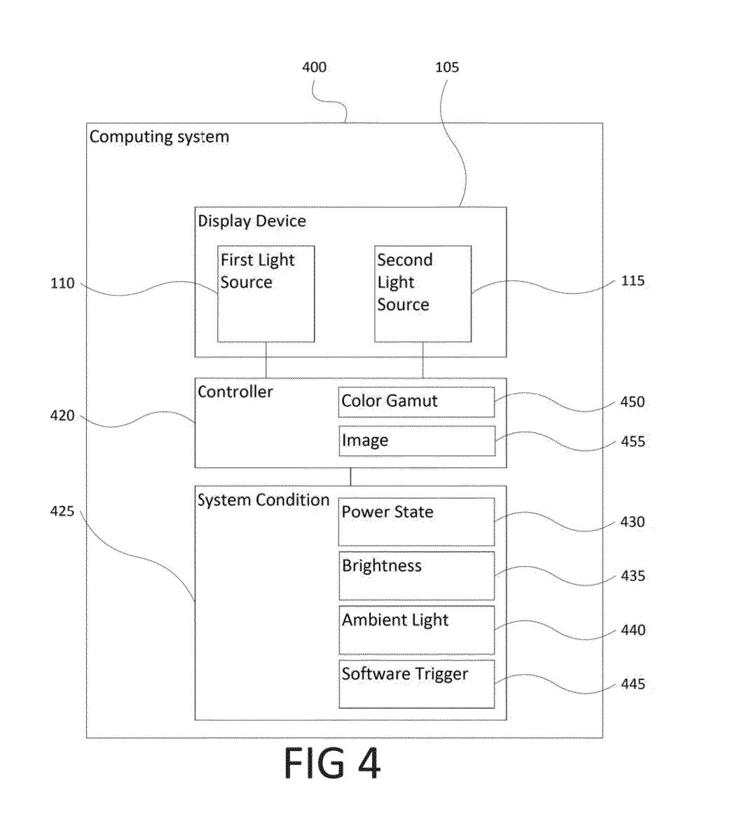

FIG. 4 is a block diagram of a computing system including a display light source according to an example implementation. The computing system 400 can include first light source 110 and a second light source 115. In one example the first light source is illuminated in the first system condition state and the second light source 115 is illuminated in the second system condition state. The controller 420 may illuminate the first light source 110 in the second system condition state in addition to illuminating the second light source 115.

The controller 420 can determine which color gamut 450 is appropriate for a system condition 425 state. The system condition 425 state can be the power state 430 of the system which may be the power source or an ACPI state. The system condition may also be the brightness 435 setting of a display device, ambient light 440, and software setting 445 or another system condition 425.

If the controller 420 determines to illuminate the second light source 115 to widen the color gamut of the display device 105 the controller 420 may also vary the color gamut of the second light source 115. For example if the second light source 115 is made of red, green and blue light sources, any of the light sources may be illuminated independent of the other second light sources to change the color gamut such as by tuning on only the blue LED if the image 455 that the controller 420 is sending to the display device is blue such as an image of the sky or ocean. The color gamut of the first light source may not be variable so that if the second light source is adjusted to widen the color gamut in blue the white LEDs will still illuminate images on the displays that are not the color of the second light source.

If the image 455 to be displayed is black the controller 420 may turn off the first light source 110 and the second light source 115 for the portion display device that display the black image.

In one implementation, to display colors that are not the primary colors of a display pixel a color matrix calculation or a color lookup table is used to create colors other than the primary colors which may be for example red, green and blue. If the second light source 115 is illuminating the display the controller 420 may change the color matrix calculation or use an alternative lookup table for example to shift the color of the pixel to account for the difference in the color of the illumination of the display. In a color liquid crystal display (LCD) for example, to generate a white pixel from the red, green and blue portions of the pixel when the first light source is illuminating a pixel of the display may be a different ratio between red, green and blue of the pixel than when the second light source is illuminating the pixel of the display and this can be adjusted in the color matrix calculation or a look up table.

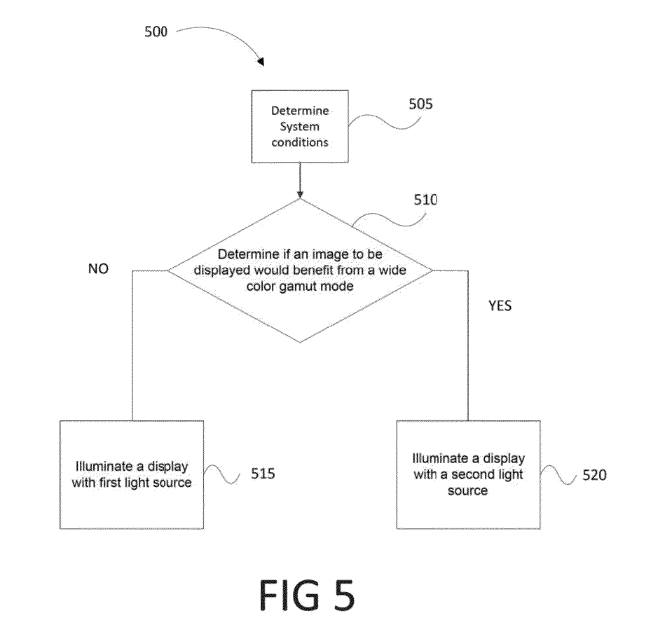

FIG. 5 is a flow diagram of a method of selectively increasing color gamut of a displayed image according to an example implementation. The method 500 of selectively increasing color gamut of a displayed image can determine system conditions at 505. The method can determine if an image to be displayed would benefit from a wide color gamut mode at 510. If it is determined the image to be displayed would not benefit from the wide color gamut mode a display can be illuminated with first light source at 515. The first light source may be for example the first light source 110. If it is determined the image to be displayed would benefit from the wide color gamut mode the display may be illuminated with a second light source at 520. The second light source may be for example the second light source 115.

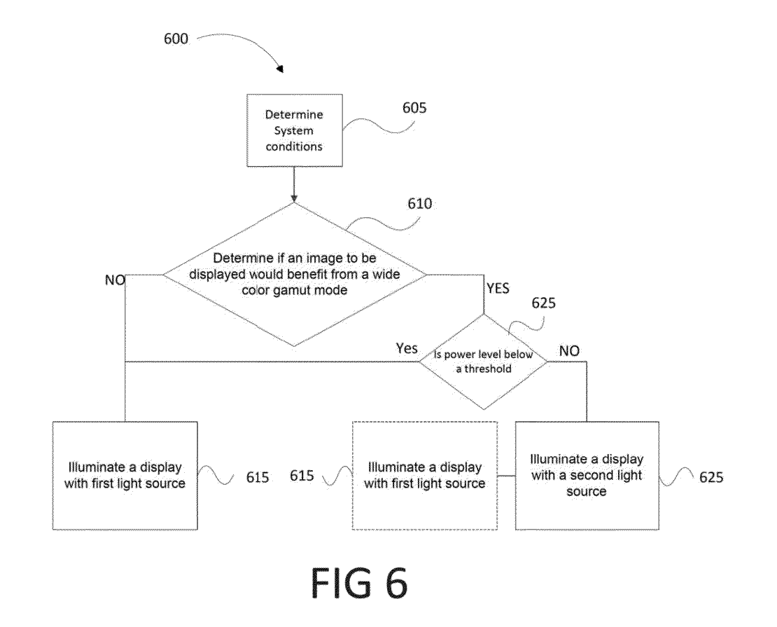

FIG. 6 is a flow diagram of a method of selectively increasing color gamut of a displayed image according to an example implementation. The method 600 of selectively increasing color gamut of a displayed image can determine system conditions at 605. The method can determine if an image to be displayed would benefit from a wide color gamut mode at 610. An image may be determined to benefit from the wide color gamut mode if it is for example a photo or a video.

If it is determined the image to be displayed would not benefit from the wide color gamut mode a display can be illuminated with first light source at 615. The first light source may be for example the first light source 110. If it is determined the image to be displayed would benefit from the wide color gamut mode the display may be illuminated with a second light source at 620. The second light source may be for example the second light source 115.

If the power level is below a threshold the display is prevented from entering the wide color gamut made at 625 and illuminates the display with the first light source at 615. If the power level is above the threshold the display can enter the wide color gamut mode and illuminate the display with a second light source at 625. If it is determined that the power level is above the threshold the display may illuminate the first light source at 615 and the second light source at 626 in the wide color gamut made.

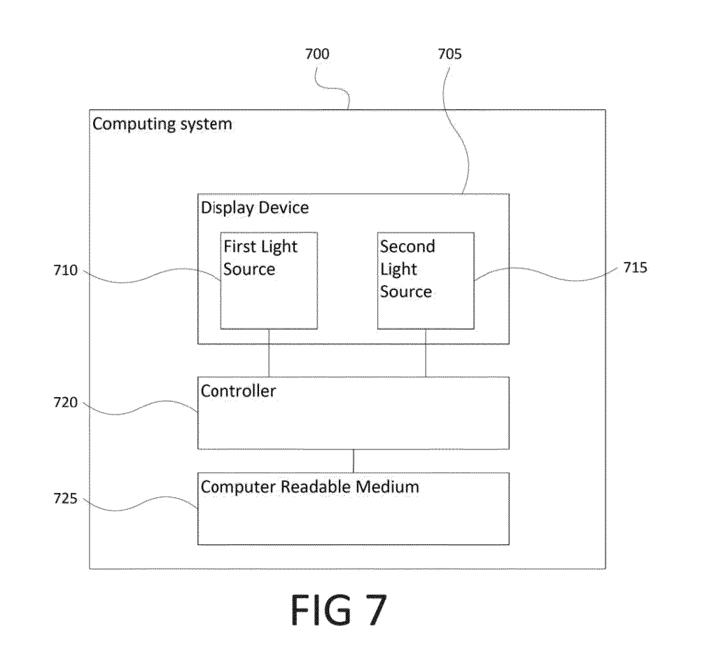

FIG. 7 is a computing system including a computer readable medium according to an example implementation. The computing system 700 can include a computer readable medium comprising code that if executed by a controller 720 causes a computing system to display an image on a display device 705. The controller can determine if the image to be displayed would benefit from a wide color gamut mode. If it is determined the image to be displayed would benefit from the wide color gamut mode the controller can enable a second light source 715 to widen the color gamut. The wider color gamut mode is in comparison to the color gamut mode of the first light source 710.

The controller 720 may illuminate the display device 705 with the first light source 710 and the second light source 725 in the wide color gamut mode.

The computing system may prevent the wide color gamut mode if it is determined that a battery charge is below a threshold amount. By preventing the wide color gamut mode below a threshold battery charge can extend the time that the computing system can operate on the remaining battery charge.

The techniques described above may be embodied in a computer-readable medium for configuring a computing system to execute the method. The computer readable media may include, for example and without limitation, any number of the following: magnetic storage media including disk and tape storage media; optical storage media such as compact disk media (e.g., CD-ROM, CD-R, etc.) and digital video disk storage media; holographic memory; nonvolatile memory storage media including semiconductor-based memory units such as FLASH memory, EEPROM, EPROM, ROM; ferromagnetic digital memories; volatile storage media including registers, buffers or caches, main memory, RAM, etc.; and the Internet, just to name a few. Other new and various types of computer-readable media may be used to store the software modules discussed herein. Computing systems may be found in many forms including but not limited to mainframes, minicomputers, servers, workstations, personal computers, notepads, personal digital assistants, various wireless devices and embedded systems, just to name a few.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A computing system comprising:
a display device to display an image;
a first light source in the white color gamut to illuminate the image on the display device;
a second light source different in color gamut than the first light source to illuminate the image on the display device;
a controller to illuminate the first light source in a first system condition and illuminate the second light source in a second system condition.

2. The system of claim 1, wherein the controller illuminates the first light source in the second system condition.

3. The system of claim 1, wherein the system condition is the power state of the system.

4. The system of claim 1, wherein the color gamut of the second light source is variable.

5. The system of claim 4, wherein the color gamut of the second light source changes in response to an image to be displayed on the display device.

6. The system of claim 5, wherein the color gamut of the first light source is not variable.

7. The system of claim 1, further comprising a liquid crystal display wherein the first light source and the second light source are a backlight for the liquid crystal display.

8. The system of claim 1, wherein the first light source and the second light source are turned off when an image displayed is black.

9. A method of selectively increasing color gamut of a displayed image comprising:
determining if an image to be displayed would benefit from a wide color gamut mode;
illuminating a display with a first light source if it is determined the image o be displayed would not benefit from the wide color gamut mode; and
illuminating the display with a second light source if it is determined the image to be displayed would benefit from the wide color gamut mode.

10. The method of claim 9, further comprising illuminating the display with the first light source and the second light source in the wide color gamut.

11. The method of claim 9, further comprising preventing the wide color gamut mode if it is determined that a battery capacity is below a threshold amount.

12. The method of claim 9, wherein at east one of a video and a photo are determined to benefit from a wide color gamut.

13. A computer readable medium comprising code that if executed by a controller causes a computing system to:
display an image on a display device;
determine if the image to be displayed would benefit from a wide color gamut mode;
enabling a second light source to widen the color gamut if it is determined the image to be displayed would benefit from the wide color gamut mode.

14. The computer readable medium of claim 13 further comprising code that if executed causes a computing device to:
illuminate the display with the first light source and the second light source in the wide color gamut.

15. The computer readable medium of claim 13 further comprising code that if executed causes a computing device to:
prevent the wide color gamut mode if it is determined that a battery capacity is below a threshold amount.
